(19) United States
(12) Patent Application Publication
(10) Pub. No.: US 2025/0392499 A1
(43) Pub. Date: Dec. 25, 2025

(54) MULTI-DECISION FEEDBACK EQUALIZATION IN A RECEIVER DEVICE

(71) Applicant: Marvell Asia Pte Ltd, Singapore (SG)

(72) Inventors: Masoud BARAKATAIN, San Jose, CA (US); Jamal RIANI, Best (NL); Volodymyr SHVYDUN, Union City, CA (US); Sek Kin NENG, San Jose, CA (US)

(21) Appl. No.: 19/246,341

(22) Filed: Jun. 23, 2025

Related U.S. Application Data
(60) Provisional application No. 63/662,995, filed on Jun. 21, 2024.

(51) Int. Cl. H04L 25/03; H04B 10/60

(52) U.S. Cl. CPC H04L 25/03057; H04B 10/60

(57) ABSTRACT

A receiver device receives a signal transmitted to the receiver device over an optical communication channel and equalizes the signal using a multi-decision feedback equalizer of the receiver device. Equalizing the signal includes generating, using at least one decision feedback equalizer configured with a plurality of slicing thresholds, decisions on symbols transmitted to the receiver device, detecting that a decision made by the decision feedback equalizer is unreliable. Equalizing the signal also includes, in response to detecting that the decision is unreliable, tracking, for a tracking period, multiple decision paths that generate respective possible sequences of symbols transmitted to the receiver device, determining error energies in decisions made, during the tracking period, in respective decision paths, and selecting, based on a comparison between the respective error energies, a sequence of symbols generated in one of the multiple decision paths as an output of the multi-decision feedback equalizer.

### CROSS REFERENCES TO RELATED APPLICATIONS

This application claims the benefit of U.S. Provisional Patent App. No. 63/662,995, entitled “Multi-Decision Feedback Equalization Approach for IM/DD Links,” filed on Jun. 21, 2024, the disclosure of which is hereby expressly incorporated herein by reference in its entirety.

### FIELD OF TECHNOLOGY

The present disclosure relates generally to communication links, and more particularly to equalization of signals received over communication links.

### BACKGROUND

Data speeds in optical communication systems have increased greatly over the years. For example, the standardization of a 200 gigabits per second (Gb/s) per wavelength scheme is currently being finalized for data-center interconnect applications. Transmissions of signals over optical communication channels in such communication systems are susceptible to inter-symbol interference (ISI) in the communication channel. A receiver device thus typically performs equalization of the receive signal to mitigate the effects of ISI on the signal transmitted over the communication channel. As the throughputs continue to increase, ISI intensifies due to factors such as chromatic dispersion, cross talk, and bandwidth limited transceiver components.

Conventionally, a decision-feedback equalizer (DFE) is used as a simple and low-power solution for post-cursor ISI mitigation. The DFE generates decisions on transmitted symbols by comparing an observed level of a receive signal to one or more slicing thresholds to map the received symbol on one of possible transmitted symbols. A typical DFE equalizes the receive signal by subtracting effects of one or more previous symbol on the current signal based on decisions made by the DFE for the one or more previous symbols. The DFE then compares an observed level of the equalized current signal to the one or or more slicing thresholds to generate the decision on the current symbol.

The performance of a typical DFE is often sub-optimal. For example, a typical DFE only exploits a small number of previous decisions (e.g., only one decision in a 1-tap DFE) in mitigating ISI. Such equalization is insufficient and leads to errors in some situations, particularly in high throughput applications. Moreover, a DFE multiplies errors in the feedback loop, turning a single error into a burst error and limiting the overall performance of the receiver.

Optimal performance may be obtained by maximum likelihood sequence detection (MLSD), where the received sequence is compared with all possible symbol sequences to obtain the most likely transmitted symbol sequence. For example, a Viterbi algorithm may be used on a trellis to find the most probable transmitted sequence methodically with managed complexity. However, the complexity, power consumption, and latency of MLSD is too high or prohibitive in many high-throughput applications.

### SUMMARY

In an embodiment, a method for signal equalization in a communication system including: receiving, by a receiver device, a signal transmitted to the receiver device over an optical communication channel; and equalizing the signal using a multi-decision feedback equalizer of the receiver device, including generating, using at least one decision feedback equalizer of the multi-decision feedback equalizer, decisions on symbols transmitted to the receiver device, wherein the at least one decision feedback equalizer is configured with a plurality of slicing thresholds, detecting that a decision made by the at least one decision feedback equalizer is unreliable, in response to detecting that the decision made by the at least one decision feedback equalizer is unreliable, tracking multiple decision paths for a tracking period, wherein respective ones of the multiple decision paths generate respective possible sequences of symbols transmitted to the receiver device, determining error energies in decisions made, during the tracking period, in respective decision paths among the multiple decision paths, and selecting, based on a comparison between the respective error energies in the respective decision paths, a sequence of symbols generated in one of the multiple decision paths as an output of the multi-decision feedback equalizer.

In another embodiment, a receiver device, comprising: a communication interface configured to receive a signal transmitted to the receiver device over an optical communication channel; and a multi-decision feedback equalizer including at least one decision feedback equalizer configured to generate decisions on symbols transmitted to the receiver device, wherein generating the decisions includes comparing observed values of the signal to a plurality of slicing thresholds of the at least one decision feedback equalizer; and an equalizer output selector configured to detect that a decision made by the at least one decision feedback equalizer is unreliable, in response to detecting that the decision made by the at least one decision feedback equalizer is unreliable, track multiple decision paths for a tracking period, wherein respective ones of the multiple decision paths generate respective possible sequences of symbols transmitted to the receiver device, determine error energies in decisions made, during the tracking period, in respective decision paths among the multiple decision paths, and select, based on a comparison between the respective error energies in the respective decision paths, a sequence of symbols generated in one of the multiple decision paths as an output of the decision feedback equalizer.

### BRIEF DESCRIPTION OF THE DRAWINGS

FIG. 1 is a block diagram of an example communication system in which a receiver device is configured to perform multi-decision feedback equalization, according to an embodiment.

FIG. 2 is a plot showing low reliability decision regions of a decision feedback equalizer for four level pulse amplitude modulation (PAM4) signals, according to an embodiment.

FIG. 3 is a block diagram of a multi-decision feedback equalizer that includes two decision paths to detect and resolve low reliability decisions, according to an embodiment.

FIG. 4 is a plot showing biasing of slicing thresholds used with a decision feedback equalizer for PAM4 signals, according to an embodiment.

FIG. 5 is a block diagram of a multi-decision feedback equalizer that includes four decision paths to detect resolve low reliability decisions, according to an embodiment.

FIG. 6 is a block diagram of an example multi-decision feedback equalizer that utilizes error ternary feedback equalization, according to an embodiment.

FIG. 7 is a block diagram of an example error ternary circuit used with the multi-decision feedback equalizer of FIG. 6, according to an embodiment.

FIG. 8 is a block diagram of a threshold adjustment circuit for relative level margin (RLM) correction in a decision feedback equalizer, according to an embodiment.

FIG. 9 is a flow diagram illustrating an example method for multi-decision feedback equalization, according to an embodiment.

### DETAILED DESCRIPTION

In embodiments described below, a receiver device is configured to equalize a receive signal using a multi-decision feedback equalizer that includes multiple decision paths configured to generate respective decision sequences based on the signal received by the receiver device. In an embodiment, the multi-decision feedback equalizer is configured to i) detect situations in which a decision made based on a receive signal is unreliable and ii) in response to detecting that a decision is unreliable, follow multiple decision sequences corresponding to the multiple decision paths and select a decision sequence that has a lowest noise-energy among the multiple decision paths.

In an embodiment, the decision paths of the multi-decision feedback equalizer include respective decision feedback equalizers configured to operate in parallel with biased slicing thresholds to detect that a decision made by the multi-decision feedback equalizer is unreliable, and, in response to detecting that a decision is unreliable, follow decisions in the multiple decision paths for a tracking period, for example until convergence of decisions in the multiple decision paths. The multi-decision feedback equalizer also includes an equalizer output selector configured to determine error energies in the multiple decisions paths based on the decisions made in the multiple decision paths during the tracking period, and to select the symbol sequence corresponding to the decision path with the lowest error energy among the multiple decision paths.

In another embodiment, the multi-decision feedback equalizer includes a decision feedback equalizer coupled to an error ternary circuit. The error ternary circuit is configured to detect unreliable decisions of the decision feedback equalizer based on the magnitude of an error signal associated with decisions made by the decision feedback equalizer. The error ternary circuit includes multiple paths that are configured to predict, based on magnitude and sign of the error associated with decisions made by the decision feedback equalizer, directions in which the decisions are to be shifted to generate alternative decisions for the decisions made by the decision feedback equalizer. The multi-decision feedback equalizer is configured to generate one or more alternate decision sequences based on the decision sequence generated by the decision feedback equalizer and the output of the error ternary circuit. In such embodiments, the decisions generated by the decision feedback equalizer correspond to a first decision path and the generated alternate decisions correspond to one or more second decision paths. The multi-decision feedback equalizer also includes an equalizer output selector configured to select a path, from among the first decision path and the one or more second decision paths, based on error energies determined based on decisions of the first decision path and the decisions of the one or more second decision paths. Accordingly, in an embodiment, the multi-decision feedback equalizer that is implemented with the error ternary circuit is configured to detect and resolve low reliability decisions based on an output of a single decision feedback equalizer, thereby reducing complexity, area, power consumption, etc. of the multi-decision feedback equalizer as compared to multi-decision feedback equalizers in which multiple decision feedback equalizers are used to generate the multiple decision sequences corresponding to the multiple decision paths.

In various embodiments, detecting and resolving low reliability decisions made by a decision feedback equalizer as described herein allows the multi-decision feedback equalizer to achieve performance that is close to optimal performance that may be achieved using maximum likelihood sequence detection (MLSD), but with reduced complexity, power consumption, area, etc. as compared to systems that implement MLSD for signal equalization. In at least some embodiments, the reduced complexity, power consumption, area, etc. allow the multi-decision feedback equalizer to be used in high-throughput applications that require low latency, such as high-speed optical communications that may be used, for example, for artificial intelligence (AI) interconnects with tight link budgets.

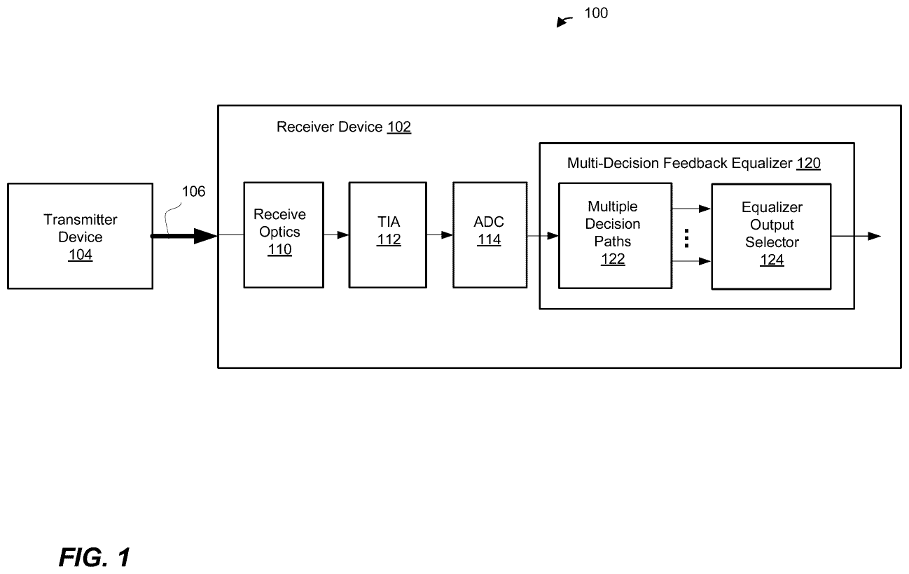

FIG. 1 is a block diagram of an example communication system 100 in which a receiver device 102 is configured to perform multi-decision feedback equalization, according to an embodiment. The communication system 100 includes the receiver device 102 communicatively coupled to a transmitter device 104 via a communication link (sometimes referred to herein as “communication channel”) 106. In an embodiment, the receiver device 102 and the transmitter device 104 are parts of switching or host devices employed in a datacenter, for example for transmission and reception of high-speed data by devices in the datacenter. In other embodiments, the receiver device 102 and/or the transmitter device 104 are transmitter/receiver devices employed in suitable communications networks other than in a datacenter. In an embodiment, the communication link 106 comprises an optical communication link, such as a fiber communication link suitable for transmission of high-speed data. In other embodiments, the communication link 106 comprises other suitable types of communication links, such other suitable types of optical communication links, a wired communication link, a wireless communication link, etc. In an embodiment, the communication link 106 is an intensity modulation direct detection (IM/DD) communication link or a communication link that utilizes a suitable format different from IM/DD.

The receiver device 102 includes receive optics 110 that are optically coupled to the communication link 106 and are configured to receive an optical signal via the communication link 106. In an embodiment, the signal is a modulated signal that is transmitted to the receiver device 102 over the communication channel 106. For example, the signal is a PAM4 modulated signal. In other embodiments, the signal is modulated according to multi-level modulations other than PAM4 modulation (e.g., a suitable higher order PAM modulation, such as PAM3 modulation, PAM5 modulation, PAM6 modulation, PAM7 modulation, PAM8 modulation, etc.). As another example, the signal is modulated according to two-level, or PAM2, modulation. The receive optics 110 are configured to convert the optical signal to an analog electrical current signal. For example, the receive optics 110 include a photodiode that is configured to convert the optical signal to an analog electrical current signal.

A transimpedance amplifier (TIA) 112 is coupled to the receive optics 110 and is configured to convert the analog electrical current signal to an analog electrical voltage signal. An analog-to-digital converter (ADC) 114 is configured to convert the analog electrical voltage signal to a digital receive signal (sometime referred to herein as simply “receive signal”).

The digital receive signal is provided to a multi-decision feedback equalizer 120. The multi-decision feedback equalizer 120 is configured to equalize the receive signal to mitigate inter-symbol interference caused by transmission of the optical signal over the communication channel 106, in an embodiment. The multi-decision feedback equalizer 120 is configured to use decision feedback equalization to equalize the receive signal by subtracting decisions made for one or more previous symbols multiplied by respective one or more channel coefficients to equalize the current receive signal. For example, a one-tap DFE equalizes the current receive signal by subtracting the previous decision d(i−1) multiplied by a tap coefficient α from the current receive signal xᵢ. The equalized receive signal is provided to a slicer of the DFE that compares an observed level of the equalized receive signal to one or more slicing thresholds to map the observed level of the equalized receive signal to one of a plurality of possible transmitted symbols. For example, in an embodiment in which four-level pulse amplitude modulation (PAM4) is used, the DFE is configured with at least three different slicing thresholds, including a first slicing threshold, a second slicing threshold, and a third slicing threshold. The DFE maps the equalized receive signal to one of four possible transmitted symbols based on whether the observed level of the equalized receive signal is i) below the first threshold, ii) between the first threshold and a second threshold, iii) between the second threshold and the third threshold, or iv) above the third threshold. As just an example, with PAM4 constellation symbols represented by {0, 1, 2, 3}, the DFE is configured to use threshold of {0.5, 1.5, 2.5} to map the observed level of the receive signal to one of the four possible constellation symbols.

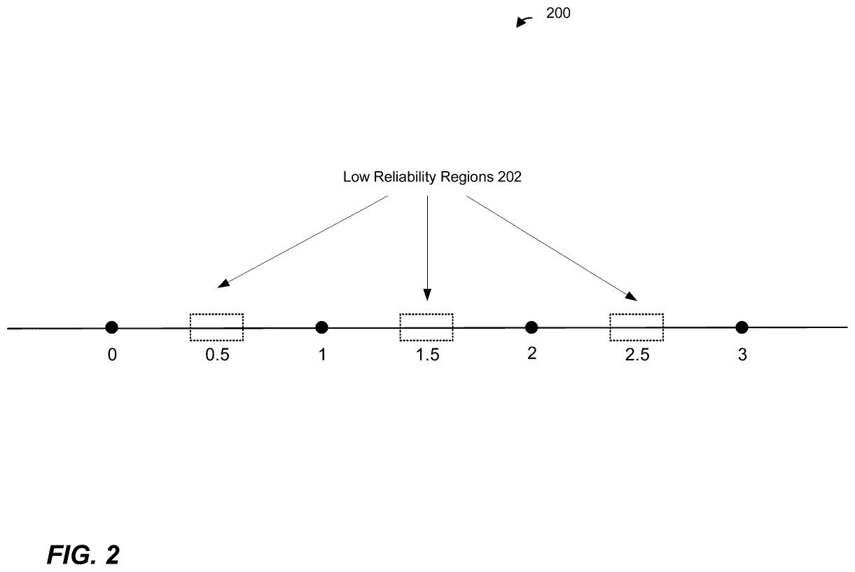

Decisions of a DFE are generally less reliable when the observed level of the receive signal at the input to the slicer is close to a slicing threshold of the slicer. Referring, for example, to FIG. 2, a plot 200 illustrates low reliability regions in detection of PAM4 constellation symbols represented by {0, 1, 2, 3}. In the example of FIG. 2, slicing thresholds {0.5, 1.5, 2.5} are set between respective signal levels corresponding to the constellation symbols {0, 1, 2, 3}. The plot 200 illustrates low reliability regions 202 close to the slicing thresholds {0.5, 1.5, 2.5}. Generally, a DFE makes reliable decisions when an observed receive signal falls outside of any low reliability region 202. On the other hand, the DFE makes less reliable (also sometimes referred to herein as “unreliable”) decisions when an observed receive signal falls within a low reliability regions 202, in an embodiment.

In embodiments described herein, the multi-decision feedback equalizer 120 includes multiple decision paths 122 configured to generate respective decision sequences corresponding to possible transmitted symbols. The multi-decision feedback equalizer 120 also includes an equalizer output selector 124 configured to detect cases in which an observed value of the receive signal falls within a low reliability region of the multi-decision feedback equalizer 120 and, in response to detecting a low reliability decision, follow multiple decision sequences generated in the multiple decision paths 122 for a tracking period, for example until convergence of decisions made in the multiple decision paths. The equalizer output selector 124 is configured to determine error energies based on decisions generated in respective ones of the decision paths 122 during the tracking period, and to select, as an output of the multi-decision feedback equalizer 120, a symbol sequence generated in the decision paths with lowest error energy among the multiple decision paths, in an embodiment.

It is noted that although the DFEs and multi-decision feedback equalization techniques are generally described herein with reference to PAM4 modulated signals for illustrative purposes, similar DFEs and multi-decision feedback equalization techniques are used with other modulations (e.g., PAM2, PAM3, PAM5, PAM6, PAM7, PAM8, etc.), in other embodiments. The slicers of such DFEs are generally configured with a number of slicing thresholds that depends on the number of levels used in the modulation. In such embodiments, the decisions of the DFE are unreliable when the receive signal at the input to the slicer is within a low reliability range defined around any of the slicing thresholds of the DFE. As just an example, in an embodiment in which PAM2 modulation is used, the slicer of the DFE is configured with a single slicing threshold, and the decisions of the DFE are unreliable when the receive signal at the input to the slicer is within a low reliability range defined around the single slicing threshold. As another example, in an embodiment in which PAM3 modulation is used, the slicer of the DFE is configured with two slicing thresholds, and the decisions of the DFE are unreliable when the receive signal at the input to the slicer is within a low reliability range defined around any slicing threshold among the two slicing thresholds. As another example, in an embodiment in which PAM5 modulation is used, the slicer of the DFE is configured with four slicing thresholds, and the decisions of the DFE are unreliable when the receive signal at the input to the slicer is within a low reliability range defined around any slicing threshold among the four slicing thresholds, etc.

In an embodiment, decision paths among the multiple decision paths 122 include respective DFEs configured to operate in parallel with thresholds that are offset in different directions with respect to corresponding nominal thresholds of the multi-decision feedback equalizer 120. The nominal thresholds are set, for example, in the middle between signal levels corresponding to respective possible transmitted symbols. The offset of the thresholds of the respective DFEs defines the low reliability regions of respective DFEs. In an embodiment, when the observed level of the receive signal falls outside of any low reliability region, the multiple DFEs generate a same decision. In this case, the equalizer output selector 124 is configured to output the decision without further processing, in an embodiment. On the other hand, when the observed level of the receive signal falls within a low reliability region, the decisions made by the multiple DFEs are different due to the offset in the thresholds of the DFEs. In this case, as described in more detail below, the equalizer output selector 124 is configured to follow outputs of the multiple DFEs for a tracking period, for example until the decisions of the multiple DFEs are again in agreement, and to select, as the output of the multi-decision feedback equalizer 120, a decision sequence with a smallest error energy amongst the decision sequences generated by the multiple DFEs.

As another example, in another embodiment, the multi-decision feedback equalizer 120 is configured as an error ternary feedback equalizer configured to detect and resolve low reliability situations in which the observed receive signal level is close to a nominal threshold of the multi-decision feedback equalizer 120. In this embodiment, the multi-decision feedback equalizer 120 is configured to generate decisions using a single DFE and to detect a low reliability decision based on a magnitude of an error signal corresponding to the decision made by the single DFE. As described in more detail below, the multiple decision paths 122 of the error ternary feedback equalizer are configured to generate alternative decisions based on the decisions and errors generated by the single DFE. The equalizer output selector 124 is configured to follow the alternate decisions for a tracking period, for example until convergence of the decisions, and to select, as the output of the multi-decision feedback equalizer 120, a decision sequence with a smallest error energy amongst the alternate decision sequences.

These and other techniques described herein improve reliability of the multi-decision feedback equalizer 120 as compared to conventional decision feedback equalizers that do not generate multiple parallel decision sequences. In at least some embodiments, the multi-decision feedback equalizer 120 achieves performance that is the same as or close to systems that utilize maximum likelihood sequence detection (MLSD), but with significantly lower complexity, latency, cost, etc., in various embodiments. The multi-decision feedback equalizer 120 is suitable for high-throughput applications that require low latency, such as high-speed optical communications that may be used, for example, for artificial intelligence (AI) interconnects with tight link budgets, in various embodiments.

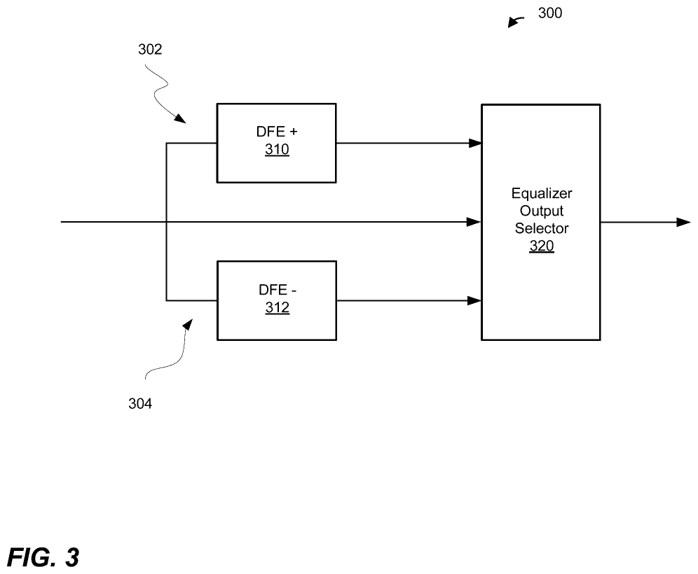

FIG. 3 is a block diagram of a multi-decision feedback equalizer 300 that includes two decision-feedback equalizers (DFEs) operating in parallel, according to an embodiment. The multi-decision feedback equalizer 300 corresponds to the multi-decision feedback equalizer 120 of FIG. 1, in an embodiment. The multi-decision feedback equalizer 300 includes a first decision path 302 and a second decision path 304. The first decision path 302 includes a first DFE 310. The second decision path 304 includes a second DFE 312. A receive signal is provided to each of the decision paths 302, 304. The first DFE 310 of the first decision path 302 generates a first decision sequence based on the receive signal. The second DFE 312 of the second decision path 304 generates a second decision sequence based on the receive signal. The output of the first DFE 310 generated in the first decision path 302 and the output of the second DFE 312 generated in the second decision path 304 are provided to an equalizer output selector 320. The receive signal based on which the decisions are generated by the first DFE 310 and the second DFE 312 is also provided to the equalizer output selector 320. The equalizer output selector 320 is configured to detect situations in which decisions made by the DFE 310, 312 are unreliable, to follow the decision sequences made by the DFE 310, 312 for a tracking period upon detection of an unreliable decision, and to select one of the decision sequences as an output of the multi-decision equalizer, in an embodiment.

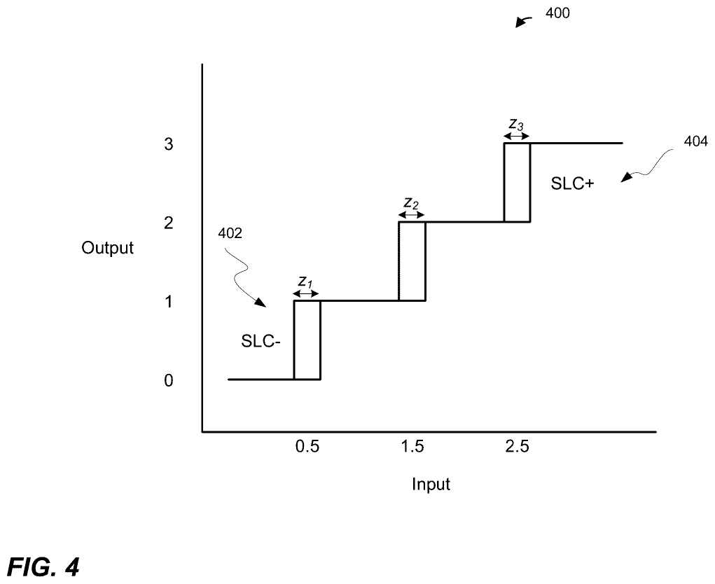

In an embodiment, the first DFE 310 and the second DFE 312 are configured to operate with slicing thresholds that are biased in different directions with respect to corresponding nominal slicing thresholds of the multi-decision feedback equalizer 300. Referring to FIG. 4, plots 402, 404 show input/output relationships of DFEs of the multi-decision feedback equalizer 300, according to an embodiment. The plot 402 corresponds to an input/output relationship of the first DFE 310 and the plot 404 corresponds to an input/output relationship of the second DFE 312, in an embodiment. The vertical axis in FIG. 4 corresponds to possible levels of a PAM4 symbol, and the horizontal axis in FIG. 4 corresponds to observed signal levels at inputs to slicers of the DFEs that map to the possible levels of the PAM4 symbol. The possible levels of a PAM4 symbol are {0, 1, 2, 3}, in the illustrated embodiment. The DFEs of the multi-decision feedback equalizer 120 are configured to use nominal slicing thresholds that are between (e.g., in the middle of) respective possible PAM4 levels, in an embodiment. The nominal slicing thresholds are thus {0.5, 1.5, 2.5}, in the illustrated embodiment. In an embodiment, as illustrated in FIG. 4, each slicing threshold of the first DFE 310 is biased in the negative direction (to the left) relative to the corresponding nominal slicing threshold and each slicing threshold of the second DFE 312 is biased in the positive direction (to the right) relative to the corresponding nominal slicing threshold. Accordingly, the first DFE 310 operates with slicing thresholds that are below (e.g., slightly below) the corresponding nominal slicing thresholds of the multi-decision feedback equalizer 300 and the second DFE 312 operates with slicing thresholds that are above (e.g., slightly above) the corresponding nominal slicing thresholds of the multi-decision feedback equalizer 300, in an embodiment.

In an embodiment, as illustrated in FIG. 4, each slicing threshold of the first DFE 310 is biased in the negative direction with respect to the corresponding nominal slicing threshold by a value of z/2 and each slicing threshold of the second DFE 312 is biased in the positive direction with respect to the corresponding nominal slicing threshold by a value of z/2. The parameter z, sometimes referred to as erasure length, defines an erasure interval in which the outputs of the two DFEs are different for the same input signal. In an embodiment, the value of z is the same for each of the slicing thresholds. In another embodiment, different values of z are used for different slicing thresholds, for example to account for different erasure lengths associated with different transmitted modulation symbols. In an embodiment, the values of the erasure length z are selected to be sufficiently small such that the decisions of the first DFE 310 and the second DFE 312 are the same for most received symbols. However, when an observed input signal falls within an erasure interval, due to the biasing of the first DFE 310 and the second DFE 312, the decisions of the first DFE 310 and the second DFE 312 are different.

Although, for illustrative purposes, the DFEs 310, 312 are generally described herein with reference to PAM4 modulation and, accordingly, three slicing thresholds, the DFEs 310, 312 are configured to operate with other modulations (e.g., PAM2, PAM3, PAM5, PAM6, PAM7, PAM8, etc.) with corresponding other numbers of slicing thresholds (e.g., one, two, four, five, six, seven, etc. slicing thresholds), in other embodiments. In such embodiments, each of the slicing thresholds of the DFE 310 is biased in the negative direction with respect to the corresponding nominal slicing threshold and each of the slicing thresholds of the DFE 312 is biased in the positive direction with respect to the corresponding nominal slicing threshold.

Decisions made by the first DFE 310 and the second DFE 312 are provided to the equalizer output selector 320. The equalizer output selector 320 selects decisions of the first DFE 310 or the second DFE 312 to be output as decisions of the multi-decision feedback equalizer. In an embodiment, the equalizer output selector 320 determines whether the decisions of the first DFE 310 and the decisions of the second DFE 312 are the same as each other. When decisions of the first DFE 310 and decisions of the second DFE 312 are the same as each other, the equalizer output selector 320 outputs the decision as the output of the multi-decision feedback equalizer 300, in an embodiment. On the other hand, in response to detecting that decisions of the first DFE 310 and the second DFE 312 are different from each other, the equalizer output selector 320 initiates a tracking period in which the equalizer output selector 320 follows decisions of the first DFE 310 and the second DFE 312 until the decisions of the first DFE 310 and the second DFE 312 converge to a same decision. In an embodiment, for the duration of the tracking period, the equalizer output selector 320 unbiases the first DFE 310 and the second DFE 312 to promote convergence of the first DFE 310 and the second DFE 312 to the same decision. Following the decisions of the first DFE 310 and the second DFE 312 includes saving the decisions in registers (not illustrated in FIG. 3) and continuing to monitor the decisions of the first DFE 310 and the second DFE 312 for convergence, in an embodiment. Once the decisions of the first DFE 310 and the second DFE 312 again become the same, the equalizer output selector 320 selects decisions amongst the decisions of the first DFE 310 and the decisions of the second DFE 312 that are most likely to be the correct decisions, for example based on the error energy in the decision paths 302, 304 determined based on respective decisions made by the DFEs 310, 312 during the tracking period. The equalizer output selector 320 is configured to select the decision sequence corresponding to the decision path with lower error signal energy among the decision paths 3102, 304, in an embodiment.

In an embodiment, the equalizer output selector 320 is configured to calculate error energy in each of the decision paths 302, 304 according to

$${\sum }_{i = m + 1}^{m + n} {( \hat{d} ( i ) + α \hat{d} ( i - 1 ) - {x}_{i} )}^{2} \qquad Equation 1$$

where {â(m+1), \hat{d}(m+2), . . . , \hat{d}(m+n)} are the decisions generated by a DFE 310, 312 during a tracking period that starts with symbol m+1 and lasts for n symbols. In an embodiment, the equalizer output selector 320 is configured to calculate the error energy based on the decisions made by the first DFE 310 and the second DFE 312 during the tracking period according to Equation 1, and select the output of the first DFE 310 or the second DFE 312 for which the error energy is lower. The equalizer output selector 320 is this configured to select the output of the first DFE 310 or the output of the second DFE 312 based on a comparison between the error signals according to

$${\sum }_{i = m + 1}^{m + n} {( {\hat{d}}_{p} ( i ) + α {\hat{d}}_{p} ( i - 1 ) - {x}_{i} )}^{2} ≶ {\sum }_{i = m + 1}^{m + n} {( {\hat{d}}_{n} ( i ) + α {\hat{d}}_{n} ( i - 1 ) - {x}_{i} )}^{2} \qquad Equation 2$$

where {\hat{d}ₚ(m+1), \hat{d}ₚ(m+2), . . . , \hat{d}ₚ(m+n)} and {\hat{d}ₙ(m+1), \hat{d}ₙ(m+2), . . . , \hat{d}ₙ(m+n)} are, respectively, the decisions of the first DFE 310 and the decisions of the second DFE 312 during the tracking period, in an embodiment.

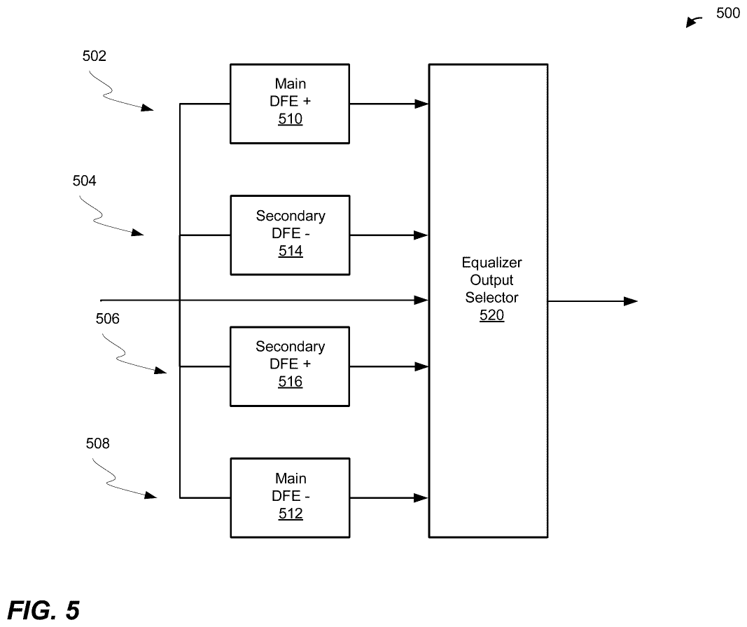

In some embodiments, the multi-decision feedback equalizer 120 includes more than two decision paths. For example, FIG. 5 is a block diagram of an example multi-decision feedback equalizer 500 that includes four decision paths. The multi-decision feedback equalizer 500 is similar to the multi-decision feedback equalizer 300 of FIG. 3. For example, the multi-decision feedback equalizer 500 includes a first decision path 502 that is the same as or similar to the first decision path 302 of the multi-decision feedback equalizer 300 and a second decision path 504 that is the same as or similar to the second decision path 304, in an embodiment. The first decision path 502 includes a first DFE 510 that is the same as or similar to the first DFE 310 of FIG. 3, in an embodiment. The second decision path 504 includes a second DFE 512 that is the same as or similar to the second DFE 312 of FIG. 3, in an embodiment. The multi-decision feedback equalizer 500 additionally includes i) a third decision path 506 that, in turn, includes a third DFE 514 and ii) a fourth decision path 508 that, in turn, includes a fourth DFE 516. Outputs of the decision paths 502-508 are provided to an equalizer output selector 520.

In an embodiment, i) the first DFE 510 and the second DFE 512 are configured to operate as “main” DFEs and ii) the third DFE 514 and the fourth DFE 516 are configured to operate as “secondary” DFEs. The first DFE 510 and the second DFE 512 are configured to operate with slicing thresholds that are biased in different directions with respect to corresponding nominal slicing thresholds of the multi-decision feedback equalizer 500. For example, similar to the first DFE 310 and the second DFE 312, each slicing threshold of the first DFE 510 is biased in the negative direction with respect to the corresponding nominal slicing threshold of the multi-decision feedback equalizer 500 by a value of z/2 and each slicing threshold of the second DFE 512 is biased in the positive direction with respect to the corresponding nominal slicing threshold of the multi-decision feedback equalizer 500 by a value of z/2, in an embodiment. Thus, similar to the first DFE 310 and the second DFE 312, the first DFE 510 and the second DFE 512 are configured such that most of the time the decisions of the first DFE 510 and the second DFE 512 are the same as each other, in an embodiment.

In an embodiment, while decisions of the first DFE 510 and the second DFE 512 are the same as each other, the third DFE 514 and the fourth DFE 516 are deactivated. When the decisions of the DFE 510 and the DFE 512 are the same as each other, the equalizer output selector 520 outputs the decision of the DFE 510, 512, without further processing, in an embodiment. In response to detecting an event in which decisions of the DFE 510, 512 are different, the equalizer output selector 520 activates the secondary DFEs 514, 516. The secondary DFE 514 is paired with the main DFE 510 and the secondary DFE 516 is paired with the main DFE 512. The DFEs 514, 516 are reverse-biased relative to the corresponding main DFEs 510, 512, in an embodiment. For example, whereas the main DFE 510 is positively biased, the secondary DFE 514 is negatively biased, in an embodiment. Similarly, whereas the main DFE 510 is negatively biased, the secondary DFE 514 is positively biased, in an embodiment.

Upon activation of the secondary DFEs 514, 516, the equalizer output selector 520 initializes the secondary DFEs 514, 516 with decisions of the corresponding main DFEs 510, 512 that caused detection of the error event, in an embodiment. Accordingly, the equalizer output selector 520 initializes the secondary DFE 514 with the decision of the main DFE 510 and ii) initializes the secondary DFE 516 with the decision of the main DFE 512, in an embodiment. The equalizer output selector 520 then tracks decisions in the four decision paths 502-508 for a tracking period, for example until detecting that the decision in the four decision paths 502-508 converge to the same decision. In response to detecting that the decision in the four decision paths 502-508 converge to the same decision, the equalizer output selector 520 terminates the tracking period. The equalizer output selector calculates error energies in the decision sequences generated in each of the four decision paths 502-508 during the tracking period. For example, the equalizer output selector 520 calculates the error energies in each of the four decision paths 502-508 according to Equation 1. The equalizer output selector 520 then selects the decision sequence that has a lowest error energy as the output of the multi-decision feedback equalizer 500, in an embodiment. The equalizer output selector 520 deactivates the secondary DFEs 514, 516 and continues operation with the biased main DFEs 510, 512 until detection of a next error event, in an embodiment.

In an embodiment, unlike in the DFEs 310, 312 of the multi-decision feedback equalizer 300, the slicers of the main DFEs 510, 512 of the multi-decision feedback equalizer 300 remain biased during the tracking period. Further, it is noted that although the secondary DFEs 514, 516 are initiated with the decisions of the corresponding main DFEs 510, 512, the decisions of the secondary DFEs 514, 516 may deviate from the decisions of the corresponding main DFEs 514, 516 due to the reverse biasing of the secondary DFEs 514, 512 relative to the corresponding main DFEs 510, 514. Thus, during the tracking period, the multi-decision feedback equalizer 500 generates four potentially different decision sequences in the four decision paths 502-508, in an embodiment.

In some embodiments, the multi-decision feedback equalizer 120 includes more than four decision paths. As just an example, the multi-decision feedback equalizer 120 is similar to the multi-decision feedback equalizer 500 of FIG. 5, but includes four additional decision paths. The additional decision paths include respective DFEs paired with DFEs 510-514. DFEs in the additional paths are activated when an unreliable decision is detected based on decisions made in a corresponding pair of decision paths 502-504, in an embodiment. Thus, in this example, the equalizer output selector 520 selects a lowest error energy decision path from among eight decision paths. In other embodiments, the multi-decision feedback equalizer 120 is similarly configured with another suitable number of decision paths, such as 16 decision paths, 32 decision paths, etc.

Referring again to FIG. 1, in some embodiments, the multi-decision feedback equalizer 120 is implemented with a decision feedback equalizer coupled to an error ternary circuit. The error ternary circuit is configured to detect unreliable decisions of the decision feedback equalizer based on the magnitude of an error signal associated with the decisions made by the decision feedback equalizer. The error ternary circuit includes multiple paths that are configured to predict, based on magnitude and sign of the error associated with decisions made by the decision feedback equalizer, directions in which the decisions are to be shifted to generate alternative decisions for the decisions made by the decision feedback equalize. The multi-decision feedback equalizer 120 is thus configured to generate one or more alternate decision sequences based on the decision sequence generated by the decision feedback equalizer and the output of the error ternary circuit, in such embodiments. In such embodiments, the decisions generated by the decision feedback equalizer correspond to a first decision path and the generated alternate decisions correspond to one or more second decision paths. The multi-decision feedback equalizer 120 also includes an equalizer output selector configured to select, as an output of the multi-decision feedback equalizer 600, a sequence from among the first decision path and the one or more second decision paths, based on error energies determined based on decisions of the first decision path and the decisions of the one or more second decision paths. In at least some embodiments, the multi-decision feedback equalizer 120 that is implemented with the error ternary circuit is configured to detect and resolve low reliability decisions based on an output of a single decision feedback equalizer, thereby reducing complexity, area, power consumption, etc. of the multi-decision feedback equalizer as compared to multi-decision feedback equalizers in which multiple decision feedback equalizers are used to generate the multiple decision sequences corresponding to the multiple decision paths.

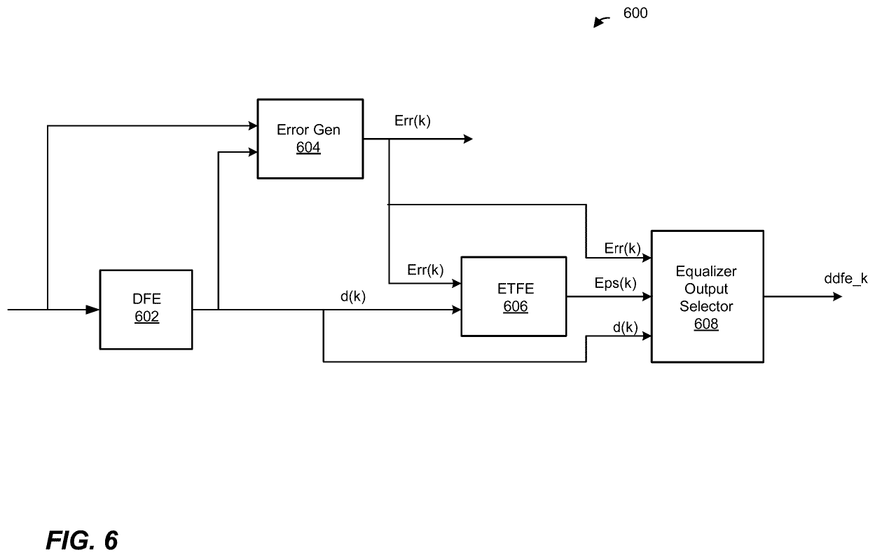

FIG. 6 is a block diagram of a multi-decision feedback equalizer 600 that utilizes error ternary feedback equalization, according to an embodiment. The multi-decision feedback equalizer 600 corresponds to the multi-decision feedback equalizer 120 of FIG. 1, in an embodiment. The multi-decision feedback equalizer 600 includes a DFE 602, an error generator 604, an error ternary circuit 606 and an equalizer output selector 608. The DFE 602 is configured to operate with nominal slicing thresholds (e.g., the slicing thresholds {0.5, 1.5, and 2.5} in an embodiment in which PAM4 modulation is used) and to generate decisions based on the nominal slicing thresholds. In other embodiments, the DFE 602 is configured to operate with other modulations (e.g., PAM2, PAM3, PAM5, PAM6, PAM7, PAM8, etc.) and with corresponding other numbers of nominal slicing thresholds (e.g., one, two, four, five, six, seven, etc. nominal slicing thresholds).

The error generator 604 is configured to generate an error signal Err(k). In an embodiment, the error signal Err(k) is generated as a difference between input signal x(k) to a slicer of the DFE 602 and the decision d(k) made based on the input signal x(k) generated by the DFE 602. The error signal Err(k) and the decision d(k) are provided to the error ternary circuit 606.

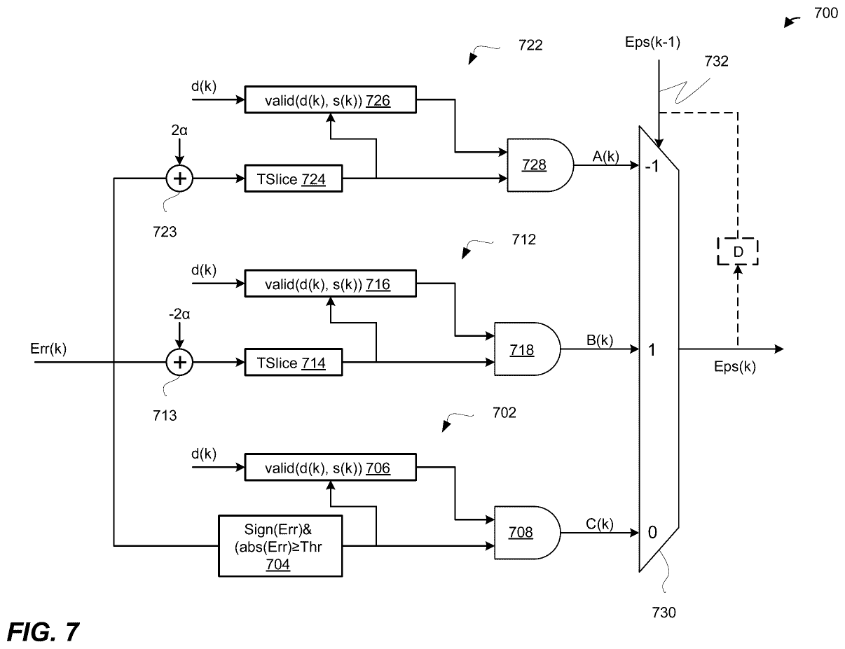

Referring to FIG. 7, an error ternary circuit 700 corresponds to the error ternary circuit 606, according to an embodiment. The error ternary circuit 700 includes a first path 702, a second path 712 and a third path 722. The first path 702 includes a comparator 704, a validity function circuit 706, and a gate 708. The second path 712 includes an adder 713, a ternary slicer 714, a validity function circuit 716, and a gate 718. The third path 722 includes an adder 723, a ternary slicer 724, a validity function circuit 726, and a gate 728.

Referring to FIGS. 6 and 7, the error ternary circuit 700 receives, as inputs, the decisions d(k) made by the DFE 602 and the error signal Err(k) generated by the error generator 604. The decisions d(k) made by the DFE 602 and the error signal Err(k) generated by the error generator 604 are provided to each of the first path 702, the second path 712, and the third path 722, in an embodiment.

In an embodiment, the output of the error ternary circuit 700 is a sequence Eps (k) which has possible values {0, 1, −1}. In an embodiment, i) the value of zero (0) of Eps (k) indicates that the decision d(k) is reliable and the alternate decision of the decision d(k) is the same as the decision d(k) ii) the value of positive one (1) of Eps (k) indicates that the decision d(k) is not reliable and that the alternate decision for the decision d(k) is shifter to the right relative to the decision d(k) and ii) the value of negative one (−1) of Eps (k) indicates that the decision d(k) is not reliable and that the alternate decision for the decision d(k) is shifted to the left relative to the decision d(k). The output of the error ternary circuit 700 is selected from among the output of the first path 702, the output of the second path 712, and the output of the third path 722, in an embodiment.

The first path 702 generally monitors the magnitude of the error signal Err(k) to detect when the magnitude of the error is sufficiently large to indicate that the observed level of the receive signal at the input to the slicer of the DFE 602 is close to a slicing threshold. As explained in more detail below, when the magnitude of the error signal Err(k) is small (e.g., below an error threshold), the first path 702 outputs a logic zero (0), indicating that the decision d(k) generated by the DFE 602 is reliable. On the other hand, as also described in more detail below, when the magnitude of the error signal Err(k) is sufficiently large (e.g., above the error threshold) to indicate that that the observed level of the receive signal at the input to the slicer of the DFE 602 is close to a slicing threshold, the first path 702 outputs a logic one (1) or a logic negative one (−1) depending on the sign of the error single Err(k), subject to there being an alternate or competitor decision that can be made based on the decision d(k) and the sign of the error signal Err(k). The sign of the error signal Err(k) indicates a direction of the error. Accordingly, the sign of the error signal Err(k) indicates a direction in which the decision d(k) is to be shifted to generate the alternate decision based on the decision d(k) and the sign of the error signal Err(k).

The comparator 704 of the first path 702 compares the absolute value of the error Err(k) to an error threshold (Thr). In an embodiment, the magnitude of the error Err(k) indicates a distance of an observed signal x(k) from a slicing threshold of the DFE 602. When the distance of an observed signal x(k) from the slicing threshold of the DFE 602 is high, this indicates that the observation falls within an unreliable decision region of the DFE 602. In an embodiment, the output of the comparator 704 is a logic zero (0) when the absolute value of the error signal Err(k) is below the error threshold. On the other hand, when the magnitude of the error signal Err(k) is equal to or greater than the error threshold, the comparator 704 outputs a logic one (1) or a logic negative one (−1) depending on the sign of the error. Thus, for example, when i) the magnitude of the error signal Err(k) is equal to or greater than the error threshold and ii) the sign of the error is positive, the comparator 704 outputs a logic one (1) and when i) the magnitude of the error signal Err(k) is equal to or greater than the error threshold and ii) the sign of the error is negative, the comparator 704 outputs a logic negative one (−1), in an embodiment.

The output of the comparator 704 is provided to the validity function circuit 706. The validity function circuit 706 determines, based on the decision d(k) and the sign of the error E (k), whether the decision d(k) has a competitor decision, i.e., whether an alternative decision exists in the direction indicated by the sign of the error Err(k), in an embodiment. In an embodiment, the validity function circuit 706 determines that the decision d(k) does not have a competitor decision if the decision is at a corner of the eye diagram and the sign of the error is pointing away from the eye, and, otherwise, determines that the decision d(k) has a competitor decision. Outputs of the comparator 708 and the validity function circuit 706 are provided to the gate 708. The gate 708 outputs i) the sign of the error the sign of the error Err(k) (−1 or 1) when the magnitude of the error Err(k) is greater than or equal to the error threshold and a competitor decision for d(k) exists and i) outputs a logic zero (0) otherwise.

The second path 712 and the third path 722 predict the alternate decision based on a current decision d(k) and the direction of shift of the previous decision d(k−1) in an embodiment. The second path 712 predicts the alternate decision for the case in which the direction of shift of the previous decision d(k−1) is negative (to the left). The third path 722 predicts the alternate decision for the case in which the direction of shift of the previous decision d(k−1) is positive (to the right).

In the second path 712, the adder 713 subtracts 2α from the error signal Err(k), where α is the tap coefficient of the DFE 602. The ternary slicer 714 outputs {1, 0, −1} based on whether the magnitude of Err(k)−2α is below zero, between zero and one, or above one, in an embodiment. The validity function circuit 716 is configured to operate as described above with reference to the validity function circuit 706, in an embodiment. The validity function circuit is configured to output a logic zero (0) or a logic one (1) based on whether a valid competitor decision exists in the direction of the sign of the error Err(k), in an embodiment. Outputs of the ternary slicer 714 and the validity function circuit 716 are provided to the gate 718. The gate 718 outputs i) the output of the ternary slicer 712 (−1, 0, or 1) when a competitor decision for d(k) exists and i) outputs a logic zero (0) otherwise, in an embodiment. Logic zero (0) at the output of the gate 718 indicates that, for the next decision d(k+1), the error ternary circuit 700 should return to the locked state in which the first path 702 monitors the magnitude of the error Err(k), in an embodiment. Logic negative one (−1) at the output of the gate 718 indicates that, for the next decision d(k+1), the error ternary circuit 700 should select the output of the third path 722. Logic one (1) at the output of the gate 718 indicates that, for the next decision d(k+1), the error ternary circuit 700 should stay with the output of the second path 712.

In the third path 722, the adder 723 adds 2a to the error signal Err(k), where a is the tap coefficient of the DFE 602. The ternary slicer 724 outputs {1, 0, −1} based on whether the magnitude of Err(k)+2a is below zero, between zero and one, or above one, in an embodiment. The validity function circuit 726 is configured to operate as described above with reference to the validity function circuit 706, in an embodiment. The validity function circuit is configured to output a logic zero (0) or a logic one (1) based on whether a valid competitor decision exists in the direction of the sign of the error Err(k), in an embodiment. Outputs of the ternary slicer 724 and the validity function circuit 726 are provided to the gate 728. The gate 728 outputs i) the output of the ternary slicer 722 (−1, 0, or 1) when a competitor decision for d(k) exists and i) outputs a logic zero (0) otherwise, in an embodiment. Logic zero (0) at the output of the gate 728 indicates that, for the next decision d(k+1), the error ternary circuit 700 should return to the locked state in which the first path 702 monitors the magnitude of the error Err(k), in an embodiment. Logic one (1) at the output of the gate 728 indicates that, for the next decision d(k+1), the error ternary circuit 700 should select the output of the second path 712. Logic negative one (1) at the output of the gate 728 indicates that, for the next decision d(k+1), the error ternary circuit 700 should stay with the output of the third path 722.

The outputs of the first path 702, the second path 712, and the third path 722 are provided to a multiplexer 730. The output of the multiplexer 730 for the current decision d(k) is selected by a signal 732 based on the previous value Eps (k−1), in an embodiment.

Referring again to FIG. 6, the output Eps (k) is provided to equalizer output selector 608. The equalizer output selector 608 is configured to generate an alternate decision sequence based on a decision sequence d(k) of the DFE 602 and the sequence Eps (k), in an embodiment. The equalizer output selector 608 is configured to generate the alternate decision sequence by, for each decision in the decision sequence d(k), keeping the decision the same, shifting the decision to the right, or shifting the decision to the left as indicated by the corresponding value (0, 1, −1) in the sequence Eps (k), in an embodiment. The equalizer output selector 608 is configured to determine error energies based on decisions d(k) generated during the tracking period and the corresponding alternate decisions, generated based on the decisions d(k) and the sequence Eps (k), in an embodiment. For example, the equalizer output selector 608 is configured to determine the error energies in as described above in connection with Equation 1. The equalizer output selector 608 is configured to select, from among the decision sequence d(k) and the alternate decision sequence generated based on the decisions d(k) and the sequence Eps (k), the sequence that has the lower error energy as an output of the multi-decision feedback equalizer 600, in an embodiment.

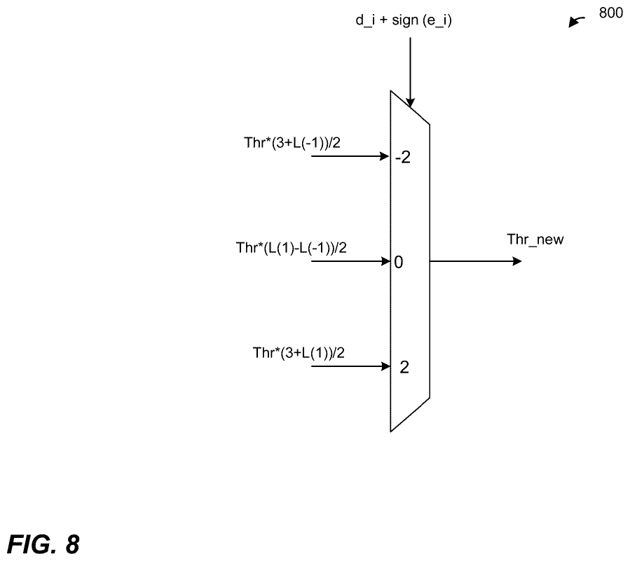

FIG. 8 is a block diagram of an error threshold adjustment circuit 800 for relative level margin (RLM) correction in a decision feedback equalizer, according to an embodiment. The error threshold adjustment circuit 800 is configured to generate different error thresholds for different modulation symbols, and select an error threshold to be used for detecting an unreliable decision based on the decision d_i and the sign of the corresponding error e_i. Referring to FIG. 8, in an embodiment, Thr represents a nominal error threshold. The error threshold adjustment circuit 800 is configured to adjust the nominal threshold Thr based on the level L of the receive signal, where the level L is not evenly distributed due to the RLM being less than 1, in an embodiment. The sign of the error e_i is {−1, +1}. The decisions d_i are {−3, −1, 1, 3} and the actual receive signal level is {−3, L(−1), L(1), 3}, in the illustrated embodiment. The selected threshold Thr_new is then used as the error threshold of comparator 704 of FIG. 7 to detect an unreliable decision based on an observed level of the receive signal, in an embodiment. Thus, the error threshold used to detect whether a decision made for an observed value of a receive signal is unreliable depends on the level of the receive signal, in an embodiment. In some embodiments in which a modulation other than PAM4 modulation is used, other numbers of levels (e.g., three levels, five levels, six levels, seven levels, etc.) are unevenly distributed due to the RLM being less than 1, in some cases. Accordingly, in some embodiments, an error threshold adjustment circuit similar to the error threshold adjustment circuit 800 is used to generate a new threshold Thr_new based on the level of the receive signal from among the corresponding other number of levels (e.g., three levels, five levels, six levels, seven levels, etc.).

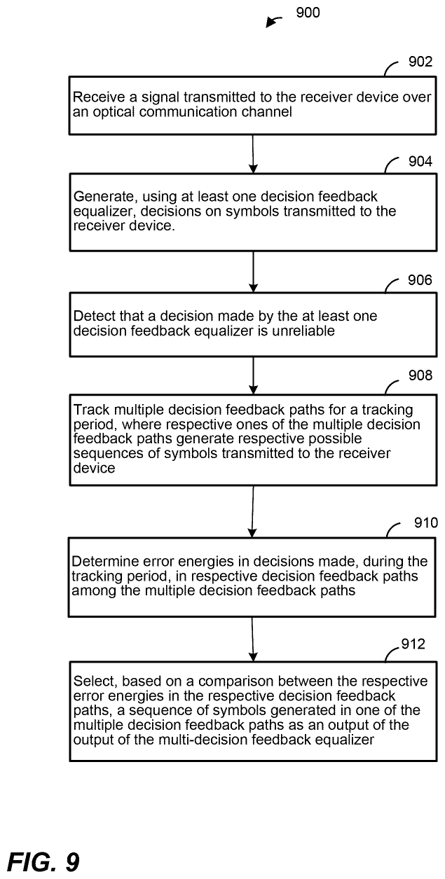

FIG. 9 is a flow diagram illustrating an example method 900 for signal equalization in a communication system, according to an embodiment. In an embodiment, the method 900 is implemented by the receiver device 102 of FIG. 1. For example, portions of the method 900 are performed by the multi-decision feedback equalizer 120 of the receiver device 102 of FIG. 1. In other embodiments, the method 900 is implemented by a suitable receiver device different from the receiver device 102 of FIG. 1 and/or portions of the method 900 are performed by a multi-decision feedback equalizer different from the multi-decision feedback equalizer 120 of the receiver device 102 of FIG. 1. For ease of explanation, the method 900 is generally described with reference to the receiver device 102 of FIG. 1.

At block 902, a signal is received by the receiver device over an optical communication channel. In an embodiment, the signal is a PAM4 modulated signal that is transmitted to the receiver device over the communication channel. In other embodiments, the signal is modulated according to modulations other than PAM4 modulation (e.g., a suitable higher order PAM modulation, such as PAM8 modulation, for example).

At block 904, decisions on symbols transmitted to the receiver device are generated using at least one decision feedback equalizer of a multi-decision feedback equalizer of the receiver device. In an embodiment, the at least one decision feedback equalizer is configured with a plurality of slicing thresholds. For example, in an embodiment in which PAM4 modulation is used, the at least one decision feedback equalizer is configured to three slicing thresholds. Thus, for example generating the decision includes i) generating a first decision based on an observed value of the signal using a first decision feedback equalizer, wherein respective slicing thresholds among multiple slicing thresholds of the first decision feedback equalizer are biased in a positive direction with respect to corresponding nominal slicing thresholds of the multi-decision feedback equalizer, and ii) generating a second decision based on the observed value of the signal using a second decision feedback equalizer, wherein respective slicing thresholds among multiple slicing thresholds of the second decision feedback equalizer are biased in a negative direction with respect to corresponding nominal slicing thresholds of the multi-decision feedback equalizer, in an embodiment. In another embodiment, generating the decisions at block 904 includes generating the decision using a single decision feedback equalizer configured to operate with nominal slicing thresholds of the multi-decision feedback equalizer.

At block 906, a decision made by the at least one decision feedback equalizer is detected as being unreliable. In an embodiment, the multi-decision feedback equalizer detects the decision as being unreliable based on detecting that decisions on an observed level of the signal made by DFEs operating with oppositely biased slicing thresholds are different from each other. Thus, for example, the multi-decision feedback equalizer detects that that the decision is based on determining that the first decision made by the first decision feedback equalizer at block 904 is different from the second decision made by the second decision feedback equalizer at block 904, in an embodiment. As another example, the multi-decision feedback equalizer detects the decision as being unreliable based on detecting that an error signal associated with a decision of a single DFE is greater than or equal to an error threshold, subject to there being an alternate decision in the direction pointed by the error signal.

At block 908, multiple decision paths are tracked by the multi-decision feedback equalizer for a tracking period. In an embodiment, respective ones of the multiple decision paths generate respective possible sequences of symbols transmitted to the receiver device. Tracking of the multiple decision paths at block 908 is performed in response to detecting that the decision made by the at least one decision feedback equalizer is unreliable at block 906, according to an embodiment. In an embodiment, tracking the multiple decision paths for the tracking period includes tracking the multiple decision paths based on i) a first sequence of symbols generated, during the tracking period, by the first decision feedback equalizer based on observed levels of the signal for a duration of the tracking period and ii) a second sequence of symbols generated, during the tracking period, by the second decision feedback equalizer based on observed levels of the signal for the duration of the tracking period. In an embodiment, tracking the multiple feedback decision paths for the tracking period includes terminating the tracking period based on determining that decisions made in respective one of the multiple feedback paths converge to a same decision.

At block 910, error energies in decisions made, during the tracking period, in respective decision paths are determined. For example, the error signal energies are determined according to Equation 1. In other embodiments, the error signal energies are determined in other suitable manners.

At block 912, a sequence of symbols generated in one of the multiple decision paths is selected as an output of the multi-decision feedback equalizer. The sequence of symbols is selected based on a comparison between the respective error energies in the respective decision paths. For example, the sequence generated in a decision path for which the determined error energy is the lowest among the multiple decision paths.

In an embodiment, the method 900 further includes, in response to detecting that the decision is unreliable at block 906, activating a third decision feedback equalizer, wherein i) slicing thresholds of the third decision feedback equalizer are reverse biased with respect to corresponding slicing thresholds of the first decision feedback equalizer and ii) activating the third decision feedback equalizer includes initializing the third decision feedback equalizer with the first decision made by the first decision feedback equalizer, and activating a fourth decision feedback equalizer, wherein i) slicing thresholds of the fourth decision feedback equalizer are reverse biased with respect to corresponding slicing thresholds of the second decision feedback equalizer and ii) activating the fourth decision feedback equalizer includes initializing the fourth decision feedback equalizer with the second decision made by the second decision feedback equalizer. In an embodiment, tracking the multiple decision paths at block 908 includes tracking the multiple decision paths based on respective sequences of symbols generated, during the tracking period, by respective ones of the first decision feedback equalizer, the second decision feedback equalizer, the third decision feedback equalizer, and the fourth decision feedback equalizer.

Embodiment 1: A method for signal equalization in a communication system, the method comprising: receiving, by a receiver device, a signal transmitted to the receiver device over an optical communication channel; and equalizing the signal using a multi-decision feedback equalizer of the receiver device, including generating, using at least one decision feedback equalizer of the multi-decision feedback equalizer, decisions on symbols transmitted to the receiver device, wherein the at least one decision feedback equalizer is configured with a plurality of slicing thresholds, detecting that a decision made by the at least one decision feedback equalizer is unreliable, in response to detecting that the decision made by the at least one decision feedback equalizer is unreliable, tracking multiple decision paths for a tracking period, wherein respective ones of the multiple decision paths generate respective possible sequences of symbols transmitted to the receiver device, determining error energies in decisions made, during the tracking period, in respective decision paths among the multiple decision paths, and selecting, based on a comparison between the respective error energies in the respective decision paths, a sequence of symbols generated in one of the multiple decision paths as an output of the multi-decision feedback equalizer.

Embodiment 2: The method of embodiment 1, wherein generating the decisions includes: generating a first decision based on an observed value of the signal using a first decision feedback equalizer, wherein respective slicing thresholds among multiple slicing thresholds of the first decision feedback equalizer are biased in a positive direction with respect to corresponding nominal slicing thresholds of the multi-decision feedback equalizer; and generating a second decision based on the observed value of the signal using a second decision feedback equalizer, wherein respective slicing thresholds among multiple slicing thresholds of the second decision feedback equalizer are biased in a negative direction with respect to corresponding nominal slicing thresholds of the multi-decision feedback equalizer.

Embodiment 3: The method of embodiment 2, wherein detecting that the decision is unreliable includes detecting that the decision is unreliable based on determining that the first decision made by the first decision feedback equalizer is different from the second decision made by the second decision feedback equalizer.

Embodiment 4: The method of either of embodiments 2 or 3, wherein tracking the multiple decision paths for the tracking period includes tracking the multiple decision paths based on i) a first sequence of symbols generated, during the tracking period, by the first decision feedback equalizer based on observed levels of the signal for a duration of the tracking period, and i) a second sequence of symbols generated, during the tracking period, by the second decision feedback equalizer based on observed levels of the signal for the duration of the tracking period.

Embodiment 5: The method of any of embodiments 2-4, wherein tracking the multiple decision paths for the tracking period includes terminating the tracking period based on determining that decisions made in respective one of the multiple decision paths converge to a same decision.

Embodiment 6: The method of any of embodiments 2-5, further comprising, in response to detecting that the decision is unreliable and prior to initiating tracking of the multiple decision paths, shifting respective slicing thresholds of the multiple slicing thresholds of the first decision feedback equalizer and respective slicing thresholds of the multiple slicing thresholds of the second decision feedback equalizer to corresponding nominal slicing thresholds of the multi-decision feedback equalizer.

Embodiment 7: The method of any of embodiments claim 2-6, further comprising: in response to detecting that the decision is unreliable, activating a third decision feedback equalizer, wherein i) slicing thresholds of the third decision feedback equalizer are reverse biased with respect to corresponding slicing thresholds of the first decision feedback equalizer; and ii) activating the third decision feedback equalizer includes initializing the third decision feedback equalizer with the first decision made by the first decision feedback equalizer, and activating a fourth decision feedback equalizer, wherein i) slicing thresholds of the fourth decision feedback equalizer are reverse biased with respect to corresponding slicing thresholds of the second decision feedback equalizer and ii) activating the fourth decision feedback equalizer includes initializing the fourth decision feedback equalizer with the second decision made by the second decision feedback equalizer, wherein tracking the multiple decision paths includes tracking the multiple decision paths based on respective sequences of symbols generated, during the tracking period, by respective ones of the first decision feedback equalizer, the second decision feedback equalizer, the third decision feedback equalizer, and the fourth decision feedback equalizer.

Embodiment 8: The method of embodiment 1, wherein detecting that the decision is unreliable includes determining a magnitude of an error associated with the decision, and determining that decision is unreliable based on determining that the magnitude of the error associated with the decision is greater than or equal to an error threshold.

Embodiment 9: The method of embodiment 8, wherein tracking the multiple decision paths includes generating alternate decisions based on decisions generated, during the tracking period, by a decision feedback equalizer configured to operate with nominal slicing thresholds of the multi-decision feedback equalizer, including generating the alternate decisions by shifting the decisions of the decision feedback equalizer in a direction indicated by signs of respective errors associated with the decisions of the decision feedback equalizer.

Embodiment 10: The method of either of embodiments 8 or 9, wherein determining that the decision is unreliable includes adjusting a value of the error threshold based on an observed level of the signal to account for relative level margin being less than 1.

Embodiment 11: A receiver device, comprising: a communication interface configured to receive a signal transmitted to the receiver device over an optical communication channel; and a multi-decision feedback equalizer including at least one decision feedback equalizer configured to generate decisions on symbols transmitted to the receiver device, wherein generating the decisions includes comparing observed values of the signal to a plurality of slicing thresholds of the at least one decision feedback equalizer; and an equalizer output selector configured to detect that a decision made by the at least one decision feedback equalizer is unreliable, in response to detecting that the decision made by the at least one decision feedback equalizer is unreliable, track multiple decision paths for a tracking period, wherein respective ones of the multiple decision paths generate respective possible sequences of symbols transmitted to the receiver device, determine error energies in decisions made, during the tracking period, in respective decision paths among the multiple decision paths, and select, based on a comparison between the respective error energies in the respective decision paths, a sequence of symbols generated in one of the multiple decision paths as an output of the decision feedback equalizer.

Embodiment 12: The receiver device of claim 11, wherein the at least one decision feedback equalizer includes: a first decision feedback equalizer configured to generate a first decision based on an observed value of the signal, wherein respective slicing thresholds among multiple slicing thresholds of the first decision feedback equalizer are biased in a positive direction with respect to corresponding nominal slicing thresholds of the multi-decision feedback equalizer; and a second decision feedback equalizer configured to generate a second decision based on the observed value of the signal, wherein respective slicing thresholds among multiple slicing thresholds of the second decision feedback equalizer are biased in a negative direction with respect to corresponding nominal slicing thresholds of the multi-decision feedback equalizer.

Embodiment 13: The receiver device of embodiment 12, wherein the equalizer output selector is configured to detect that the decision is unreliable based on determining that the first decision made by the first decision feedback equalizer is different from the second decision made by the second decision feedback equalizer.

Embodiment 14: The receiver device of either of embodiments 12 or 13, wherein the equalizer output selector is configured to track the multiple decision paths based on i) a first sequence of symbols generated, during the tracking period, by the first decision feedback equalizer based on observed levels of the signal and ii) a second sequence of symbols generated, during the tracking period, by the second decision feedback equalizer based on observed levels of the signal.

Embodiment 15: The receiver device of any of embodiments 12-14, wherein the equalizer output selector is configured to terminate the tracking period based on determining that decisions made in respective one of the multiple decision paths converge to a same decision.

Embodiment 16: The receiver device of any of embodiments claim 12-15, wherein the equalizer output selector is configured to, in response to detecting that the decision is unreliable and prior to initiating tracking of the multiple decision paths, shift respective slicing thresholds of the multiple slicing thresholds of the first decision feedback equalizer and respective slicing thresholds of the multiple slicing thresholds of the second decision feedback equalizer to corresponding nominal slicing thresholds of the multi-decision feedback equalizer.

Embodiment 17: The receiver device of any of embodiments 12-16, the equalizer output selector is configured to: in response to detecting that the decision is unreliable, activate a third decision feedback equalizer, wherein i) slicing thresholds of the third decision feedback equalizer are reverse biased with respect to corresponding slicing thresholds of the first decision feedback equalizer and ii) activating the third decision feedback equalizer includes initializing the third decision feedback equalizer with the first decision made by the first decision feedback equalizer, and activate a fourth decision feedback equalizer, wherein i) slicing thresholds of the fourth decision feedback equalizer are reverse biased with respect to corresponding slicing thresholds of the second decision feedback equalizer and ii) activating the fourth decision feedback equalizer includes initializing the fourth decision feedback equalizer with the second decision made by the second decision feedback equalizer, wherein track the multiple decision paths based on respective sequences of symbols generated, during the tracking period, by respective ones of the first decision feedback equalizer, the second decision feedback equalizer, the third decision feedback equalizer, and the fourth decision feedback equalizer.

Embodiment 18: The receiver device of embodiment 11, wherein the equalizer output selector is configured to detect that the decision is unreliable at least by: determining an error associated with the decision, including determining a magnitude of the error and a sign of the error; and determining that decision is unreliable based on determining that the magnitude of the error associated with the decision exceeds an error threshold.

Embodiment 19: The receiver device of embodiment 18, wherein the equalizer output selector is configured to generate alternate decisions based on decisions generated, during the tracking period, by a decision feedback equalizer configured to operate with nominal slicing thresholds of the multi-decision feedback equalizer, wherein the equalizer output selector is configured to generate the alternate decisions by shifting the decisions of the decision feedback equalizer in a direction indicated by signs of respective errors associated with the decisions of the decision feedback equalizer.

Embodiment 20: The receiver device of either of embodiments 18 or 19, wherein the equalizer output selector is configured to adjust a value of the error threshold based on an observed level of the signal to account for relative level margin being less than 1.

At least some of the various blocks, operations, and techniques described above are suitably implemented utilizing dedicated hardware, such as one or more of discrete components, an integrated circuit, an application-specific integrated circuit (ASIC), a programmable logic device (PLD), a processor executing firmware instructions, a processor executing software instructions, or any combination thereof. When implemented utilizing a processor executing software or firmware instructions, the software or firmware instructions may be stored in any suitable computer readable memory such as on a magnetic disk, an optical disk, or other storage medium, etc. The software or firmware instructions may include machine readable instructions that, when executed by one or more processors, cause the one or more processors to perform various acts.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A method for signal equalization in a communication system, the method comprising:
receiving, by a receiver device, a signal transmitted to the receiver device over an optical communication channel; and
equalizing the signal using a multi-decision feedback equalizer of the receiver device, including
generating, using at least one decision feedback equalizer of the multi-decision feedback equalizer, decisions on symbols transmitted to the receiver device, wherein the at least one decision feedback equalizer is configured with a plurality of slicing thresholds,
detecting that a decision made by the at least one decision feedback equalizer is unreliable,
in response to detecting that the decision made by the at least one decision feedback equalizer is unreliable, tracking multiple decision paths for a tracking period, wherein respective ones of the multiple decision paths generate respective possible sequences of symbols transmitted to the receiver device,
determining error energies in decisions made, during the tracking period, in respective decision paths among the multiple decision paths, and
selecting, based on a comparison between the respective error energies in the respective decision paths, a sequence of symbols generated in one of the multiple decision paths as an output of the multi-decision feedback equalizer.

2. The method of claim 1, wherein generating the decisions includes:
generating a first decision based on an observed value of the signal using a first decision feedback equalizer, wherein respective slicing thresholds among multiple slicing thresholds of the first decision feedback equalizer are biased in a positive direction with respect to corresponding nominal slicing thresholds of the multi-decision feedback equalizer; and
generating a second decision based on the observed value of the signal using a second decision feedback equalizer, wherein respective slicing thresholds among multiple slicing thresholds of the second decision feedback equalizer are biased in a negative direction with respect to corresponding nominal slicing thresholds of the multi-decision feedback equalizer.

3. The method of claim 2, wherein detecting that the decision is unreliable includes detecting that the decision is unreliable based on determining that the first decision made by the first decision feedback equalizer is different from the second decision made by the second decision feedback equalizer.

4. The method of claim 2, wherein:
tracking the multiple decision paths for the tracking period includes tracking the multiple decision paths based on
i) a first sequence of symbols generated, during the tracking period, by the first decision feedback equalizer based on observed levels of the signal for a duration of the tracking period, and
i) a second sequence of symbols generated, during the tracking period, by the second decision feedback equalizer based on observed levels of the signal for the duration of the tracking period.

5. The method of claim 2, wherein tracking the multiple decision paths for the tracking period includes terminating the tracking period based on determining that decisions made in respective one of the multiple decision paths converge to a same decision.

6. The method of claim 2, further comprising, in response to detecting that the decision is unreliable and prior to initiating tracking of the multiple decision paths, shifting respective slicing thresholds of the multiple slicing thresholds of the first decision feedback equalizer and respective slicing thresholds of the multiple slicing thresholds of the second decision feedback equalizer to corresponding nominal slicing thresholds of the multi-decision feedback equalizer.

7. The method of claim 2, further comprising:
in response to detecting that the decision is unreliable,
activating a third decision feedback equalizer, wherein i) slicing thresholds of the third decision feedback equalizer are reverse biased with respect to corresponding slicing thresholds of the first decision feedback equalizer and ii) activating the third decision feedback equalizer includes initializing the third decision feedback equalizer with the first decision made by the first decision feedback equalizer, and
activating a fourth decision feedback equalizer, wherein i) slicing thresholds of the fourth decision feedback equalizer are reverse biased with respect to corresponding slicing thresholds of the second decision feedback equalizer and ii) activating the fourth decision feedback equalizer includes initializing the fourth decision feedback equalizer with the second decision made by the second decision feedback equalizer, wherein
tracking the multiple decision paths includes tracking the multiple decision paths based on respective sequences of symbols generated, during the tracking period, by respective ones of the first decision feedback equalizer, the second decision feedback equalizer, the third decision feedback equalizer, and the fourth decision feedback equalizer.

8. The method of claim 1, wherein detecting that the decision is unreliable includes:
determining a magnitude of an error associated with the decision; and
determining that decision is unreliable based on determining that the magnitude of the error associated with the decision is greater than or equal to an error threshold.

9. The method of claim 8, wherein tracking the multiple decision paths includes generating alternate decisions based on decisions generated, during the tracking period, by a decision feedback equalizer configured to operate with nominal slicing thresholds of the multi-decision feedback equalizer, including generating the alternate decisions by shifting the decisions of the decision feedback equalizer in a direction indicated by signs of respective errors associated with the decisions of the decision feedback equalizer.

10. The method of claim 8, wherein determining that the decision is unreliable includes adjusting a value of the error threshold based on an observed level of the signal to account for relative level margin being less than 1.

11. A receiver device, comprising:
a communication interface configured to receive a signal transmitted to the receiver device over an optical communication channel;
a multi-decision feedback equalizer including
at least one decision feedback equalizer configured to generate decisions on symbols transmitted to the receiver device, wherein generating the decisions includes comparing observed values of the signal to a plurality of slicing thresholds of the at least one decision feedback equalizer; and
an equalizer output selector configured to
detect that a decision made by the at least one decision feedback equalizer is unreliable,
in response to detecting that the decision made by the at least one decision feedback equalizer is unreliable, track multiple decision paths for a tracking period, wherein respective ones of the multiple decision paths generate respective possible sequences of symbols transmitted to the receiver device,
determine error energies in decisions made, during the tracking period, in respective decision paths among the multiple decision paths, and
select, based on a comparison between the respective error energies in the respective decision paths, a sequence of symbols generated in one of the multiple decision paths as an output of the decision feedback equalizer.

12. The receiver device of claim 11, wherein the at least one decision feedback equalizer includes:
a first decision feedback equalizer configured to generate a first decision based on an observed value of the signal, wherein respective slicing thresholds among multiple slicing thresholds of the first decision feedback equalizer are biased in a positive direction with respect to corresponding nominal slicing thresholds of the multi-decision feedback equalizer; and
a second decision feedback equalizer configured to generate a second decision based on the observed value of the signal, wherein respective slicing thresholds among multiple slicing thresholds of the second decision feedback equalizer are biased in a negative direction with respect to corresponding nominal slicing thresholds of the multi-decision feedback equalizer.

13. The receiver device of claim 12, wherein the equalizer output selector is configured to detect that the decision is unreliable based on determining that the first decision made by the first decision feedback equalizer is different from the second decision made by the second decision feedback equalizer.

14. The receiver device of claim 12, wherein the equalizer output selector is configured to track the multiple decision paths based on i) a first sequence of symbols generated, during the tracking period, by the first decision feedback equalizer based on observed levels of the signal and ii) a second sequence of symbols generated, during the tracking period, by the second decision feedback equalizer based on observed levels of the signal.

15. The receiver device of claim 12, wherein the equalizer output selector is configured to terminate the tracking period based on determining that decisions made in respective one of the multiple decision paths converge to a same decision.

16. The receiver device of claim 12, wherein the equalizer output selector is configured to, in response to detecting that the decision is unreliable and prior to initiating tracking of the multiple decision paths, shift respective slicing thresholds of the multiple slicing thresholds of the first decision feedback equalizer and respective slicing thresholds of the multiple slicing thresholds of the second decision feedback equalizer to corresponding nominal slicing thresholds of the multi-decision feedback equalizer.

17. The receiver device of claim 12, wherein the equalizer output selector is configured to:
in response to detecting that the decision is unreliable,
activate a third decision feedback equalizer, wherein i) slicing thresholds of the third decision feedback equalizer are reverse biased with respect to corresponding slicing thresholds of the first decision feedback equalizer and ii) activating the third decision feedback equalizer includes initializing the third decision feedback equalizer with the first decision made by the first decision feedback equalizer, and
activate a fourth decision feedback equalizer, wherein i) slicing thresholds of the fourth decision feedback equalizer are reverse biased with respect to corresponding slicing thresholds of the second decision feedback equalizer and ii) activating the fourth decision feedback equalizer includes initializing the fourth decision feedback equalizer with the second decision made by the second decision feedback equalizer, wherein
track the multiple decision paths based on respective sequences of symbols generated, during the tracking period, by respective ones of the first decision feedback equalizer, the second decision feedback equalizer, the third decision feedback equalizer, and the fourth decision feedback equalizer.

18. The receiver device of claim 11, wherein the equalizer output selector is configured to detect that the decision is unreliable at least by:
determining an error associated with the decision, including determining a magnitude of the error and a sign of the error; and
determining that decision is unreliable based on determining that the magnitude of the error associated with the decision exceeds an error threshold.

19. The receiver device of claim 18, wherein the equalizer output selector is configured to generate alternate decisions based on decisions generated, during the tracking period, by a decision feedback equalizer configured to operate with nominal slicing thresholds of the multi-decision feedback equalizer, wherein the equalizer output selector is configured to generate the alternate decisions by shifting the decisions of the decision feedback equalizer in a direction indicated by signs of respective errors associated with the decisions of the decision feedback equalizer.

20. The receiver device of claim 18, wherein the equalizer output selector is configured to adjust a value of the error threshold based on an observed level of the signal to account for relative level margin being less than 1.
